(19) United States
(12) Patent Application Publication
(10) Pub. No.: US 2007/0117948 A1
(43) Pub. Date: May 24, 2007

(54) Mixtures for producing reactive hot melt adhesives and reactive hot melt adhesives obtained on the basis thereof

(75) Inventors: Gerd Loehden, Hanau (DE); Hans Goerlitzer, Dreieich (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: ROEHM GMBH & CO. KG, Darmstadt (DE)

(21) Appl. No.: 10/574,175

(22) PCT Filed: Jul. 15, 2004
(86) PCT No.: PCT/EP04/07824

§ 371 Date: Mar. 30, 2006

(30) Foreign Application Priority Data
Oct. 29, 2003 (DE) 103 50 786.8

(51) Int. Cl. C08G 18/00

(52) U.S. Cl. 528/44

(57) ABSTRACT

The invention relates to mixtures for preparing reactive hot melt adhesives based on (meth)acrylates having a polydispersity D of less than 1.8.

The present invention relates to mixtures for preparing improved reactive hot melt adhesives and also to reactive hot melt adhesives obtainable from them.

Reactive hot melt adhesives are substances which are solid at room temperature. They are melted by heating and are applied to a substrate. On cooling, the adhesive resolidifies and so bonds the substrate. Additionally the polymers present in the adhesive crosslink by reaction with moisture, producing final, irreversible curing.

Adhesives of this kind are described for example in U.S. Pat. No. 5,021,507. The principal constituent of these adhesives comprises compounds containing free isocyanate groups, obtained generally by condensation reaction between excess polyisocyanate groups and polyol. In order to improve the adhesion properties on particular substrates, binders composed of polymers formed from ethylenically unsaturated monomers have been added to these compounds containing free isocyanate groups. Binders used are typically polyalkyl (meth)acrylates having C₁ to C₁₂ alkyl groups. These compounds are polymerized by free, radical polymerization either before addition to the urethanes or in the presence thereof.

U.S. Pat No. 5,866,656 and WO 99/28363 describe reactive hot melt adhesives in which the polyalkyl (meth)acrylate binders are bound covalently to the compounds containing free isocyanate groups in the adhesive composition. Since this bonding takes place generally through a condensation reaction, those adhesives in which such bonding has developed are referred to as adhesives at the condensation stage.

The reactive adhesives obtained in this way score over U.S. Pat. No. 5,021,507 by increased elasticity and an improved adhesion to certain metal substrates and also by a longer open time, the time available for processing of the adhesive.

Nevertheless these reactive hot melt adhesives have considerable drawbacks. Thus they exhibit, for example, a low initial strength. Accordingly the substrates have to be fixed for a long time after the adhesive has been applied.

Another drawback of the prior art reactive adhesives is that on processing they exhibit a high viscosity, so making it more difficult to process the melted reactive hot melt adhesive, and in particular to apply it to porous substrates. In some cases there is also gelling at the condensation stage.

A further drawback is that the extractables content of the cured adhesive is fairly high. One of the consequences of this is to lower the adhesive's stability towards solvents.

A further drawback is the often inadequate stability of the reactive hot melt adhesive's viscosity in the melt at 130° C., therefore primarily making it more difficult to process.

In the light of the prior art identified and discussed herein the object of the present invention was to provide a reactive adhesive which has a high initial strength without any gelling at the condensation stage.

Another object of the invention was to lower the viscosity of the reactive adhesive melt at a given temperature in order to improve the processing properties of the adhesive in the melt state.

A further object of the invention was to improve the stability of the reactive adhesive's viscosity at 130° C. in the melt, in order to improve the processing properties of the adhesive in the melt state.

A further object of the invention was to provide a reactive hot melt adhesive which ensures an improved bondline elasticity and hence improved bonding of the substrates.

A further object of the invention was to provide a reactive hot melt adhesive having very good adhesion properties on different materials.

A further object of the invention was to provide a reactive hot melt adhesive which has a lower extractables content in the cured adhesive and which is highly solvent-resistant.

These and further, unspecified, objects, which will nevertheless suggest themselves immediately to the person skilled in the art from the introductory discussions of the prior art, are achieved in accordance with the invention by means of a reactive hot melt adhesive obtainable from a mixture having the features of claim 1. Advantageous modifications of this mixture of the invention for preparing a reactive hot melt adhesive are protected in the claims appendant to claim 1.

Through the use as binder of a polymer which contains hydroxyl groups and/or amino groups and/or mercapto groups and is obtainable by polymerizing ethylenically unsaturated monomers, having a polydispersity D of less than 1.8, preferably less than 1.6, more preferably less than 1.3, D being obtained from the ratio of the weight-average molecular weight M_{w} to the number-average molecular weight Mₙ, determinable for example by gel permeation chromatography, it is possible, surprisingly, to provide a reactive hot melt adhesive which has a high initial strength and does not suffer any problems with gelling at the condensation stage.

Additionally by virtue of the reactive hot melt adhesive of the invention it is possible to obtain a series of advantages over the prior art which were not readily foreseeable. These advantages include the following:

An increased initial strength and a higher elasticity in the cured bondline, obtained through the use, as binder, of a polymer containing hydroxyl groups and/or amino groups and/or mercapto groups and having a relatively high number-average molecular weight for a constant hydroxyl number, with no gelling occurring at the condensation stage.

An increased initial strength and a higher elasticity in the cured bondline, obtained through the use, as binder, of a polymer containing hydroxyl groups and/or amino groups and/or mercapto groups and having a relatively high hydroxyl number for a constant number-average molecular weight.

Easier processibility of the adhesive as a result of lower viscosity of the melt of the reactive hot melt adhesive, with the use of a polymer containing hydroxyl groups and/or amino groups and/or mercapto groups as binder, in conjunction with the same number-average molecular weight and otherwise constant conditions.

A reactive hot melt adhesive of the invention is obtainable from a mixture containing from 10 to 80 per cent by weight of a compound containing free isocyanate groups and from 20 to 90 per cent by weight of a polymer containing hydroxyl groups and/or amino groups and/or mercapto groups, obtainable by polymerizing ethylenically unsaturated monomers.

As the compound of the invention containing free isocyanate groups it is possible to choose any compound which contains two or more free isocyanate groups per molecule. Such polyisocyanates are common knowledge. Preference is given to using low molecular mass polyisocyanates containing 2 free isocyanate groups. These diisocyanates include diisocyanates whose isocyanurate groups are connected by an organic radical composed of branched or unbranched, substituted or unsubstituted aliphatic alkyl groups. Examples of such compounds are ethylene diisocyanate, ethylidene diisocyanate, propylene diisocyanate, butylene diisocyanate, hexamethylene diisocyanate and dichlorohexamethylene diisocyanate. The isocyanate groups may also be connected by radicals which contain saturated cyclic hydrocarbons. These may be unsubstituted or substituted. Included in this group are 3-isocyanatomethyl-3,3,5-trimethylcyclohexyl isocyanate, 3-isocyanatomethyl-3,3,5-trimethylcyclohexyl isocyanate cyanurate, 1,3-cyclopentylene diisocyanate, 1,4-cyclohexylene diisocyanate and 1,2-cyclohexylene diisocyanate.

Particular preferred are diisocyanates whose organic radical contains a substituted or unsubstituted aromatic. These compounds include, for example, toluene diisocyanate, 4,4-diphenylmethane diisocyanate, 2,2-diphenylpropane 4,4-diisocyanate, p-phenylene diisocyanate, m-phenylene diisocyanate, xylylene diisocyanate, 1,4-naphthylene diisocyanate, 1,5-naphthylene diisocyanate, biphenyl 4,4-diisocyanate, azobenzene 4,4-diisocyanate, diphenyl sulphone 4,4-diisocyanate, furfurylidene diisocyanate and 1-chlorobenzene 2,4-diisocyanate. Compounds having more than 2 free isocyanate groups which can be used in the context of this invention include, for example, 4,4,4-triisocyanatotriphenylmethane, 1,3,5-triisocyanatobenzene, 2,4,6-triisocyanatotoluene and 4,4-dimethyldiphenylmethane 2,2,5,5-tetraisocyanate.

Further, preferred compounds containing free isocyanate groups are oligourethanes, so-called urethane prepolymers which contain reactive isocyanate-containing end groups. Particularly preferred compounds are urethane prepolymers obtainable by polycondensation reaction of one or more low molecular mass compound containing free isocyanate groups and one or more compound containing free hydroxyl groups and/or amino groups and/or mercapto groups. Especially preferred in this context are urethane prepolymers obtainable by polycondensation of one or more low molecular mass compound containing free isocyanate groups and one or more polyhydroxy compounds. Of particular preference in this context are, in turn, dihydroxy compounds. These may be OH-terminated polyethers such as polyethylene oxide diol, polypropylene oxide diol, diol copolymers of ethylene oxide and propylene oxide, and diols of butylene oxide. Polyester polyols as well can be used, such as the OH-terminated condensation product of at least one C₂-C₁₈ dicarboxylic acid and at least one diol from the group of the C₂-C₁₆ alkylene diols. Low molecular mass diols as well, however, such as diethylene glycol, triethylene glycol, tetraethylene glycol, dipropylene glycol, tripropylene glycol and tetrapropylene glycol, for example, can be used as diol component.

In accordance with the invention it is also possible to use OH components with higher functionalization, such as polyethylene oxide triol, polypropylene oxide triol, triol copolymers of ethylene oxide and propylene oxide, and triols of butylene oxide for preparing the urethane prepolymer.

Particular preference is given to urethane prepolymers containing free isocyanate groups and obtainable by polycondensation of one or more low molecular mass diisocyanates with one or more low molecular mass diols.

In the context of this invention it is additionally possible to use urethane prepolymers obtainable by condensation polymerization of compounds containing free isocyanate groups with polyamino-containing or polymercapto-containing compounds, either alone or together with one or more compounds containing free hydroxyl groups, preferably one or more of the above-listed compounds containing free hydroxyl groups. Examples of polyamino compounds which can be used in the context of this invention are diaminopolypropylene glycol or diaminopolyethylene glycol, and also low molecular mass compounds such as ethylenediamine, hexaethylenediamine and the like; for polymercapto compounds, polythioethers. Mixed compounds as well, however, such as ethanolamine, propanolamine, N-methyldiethanolamine and the like, for example, can be used.

The molecular weight of the urethane prepolymers is generally in the range from 100 to 50 000 g/mol, preferably between 200 and 30 000 g/mol and more preferably between 500 and 20 000 g/mol, without any intention that the molecular weight should be restricted as a result.

For preparing adhesives of the invention it is possible to use as binder any polymer obtainable from ethylenically unsaturated monomers that has a hydroxyl functionality and/or amino functionality and/or mercapto functionality of together greater than 1 and a polydispersity D of less than 1.8, preferably less than 1.6, more preferably less than 1.3. In one preferred embodiment polymers are used which contain hydroxyl groups and/or amino groups and/or mercapto groups and are obtainable by copolymerizing one or more hydroxy-functionalized and/or amino-functionalized and/or mercapto-functionalized monomers and one or more monomers without such functionality, examples being alkyl esters of acrylic or methacrylic acid, vinyl esters, vinyl ethers, fumarates, maleates, styrenes and acrylonitriles. Particular preference is given to hydroxyl-carrying polymers obtainable by copolymerizing hydroxy-functionalized (meth)acrylates and (meth)acrylates without hydroxyl function.

The expression (meth)acrylates embraces methacrylates and acrylates and also mixtures of both.

These monomers are widely known. They include, among others, (meth)acrylates derived from saturated alcohols, such as methyl (meth)acrylate, ethyl (meth)acrylate, propyl (meth)acrylate, n-butyl (meth)acrylate, tert-butyl (meth)acrylate, pentyl (meth)acrylate and 2-ethylhexyl (meth)acrylate, for example;

(meth)acrylates derived from unsaturated alcohols, such as oleyl (meth)acrylate, 2-propynyl (meth)acrylate, allyl (meth)acrylate and vinyl (meth)acrylate, for example;

aryl (meth)acrylates, such as benzyl (meth)acrylate or phenyl (meth)acrylate, it being possible for the aryl radicals in each case to be unsubstituted or to be substituted up to four times;

cycloalkyl (meth)acrylates, such as 3-vinylcyclohexyl (meth)acrylate, bornyl (meth)acrylate;

(meth)acrylates of ether alcohols, such as tetrahydro-furfuryl (meth)acrylate, vinyloxyethoxyethyl (meth)acrylate;

and polyfunctional (meth)acrylates, such as tri-methyloylpropane tri(meth)acrylate,

and also the respective (meth)acrylates with hydroxyl and/or amino and/or mercapto functionalization on the substituent. These include, for example, 3-hydroxypropyl (meth)acrylate, 2-hydroxyethyl (meth)acrylate and 2-hydroxypropyl (meth)acrylate.

In addition to the (meth)acrylates set out above the compositions to be polymerized may also include further unsaturated monomers which are copolymerizable with the aforementioned (meth)acrylates.

These include, among others, 1-alkenes, such as hex-1-ene, hept-1-ene;

branched alkenes, such as vinylcyclohexane, 3,3-dimethyl-l-propene, 3-methyl-l-diisobutylene, 4-methylpent-1-ene; acrylonitrile; vinyl esters, such as vinyl acetate;

styrene, substituted styrenes with an alkyl substituent in the side chain, such as α-methylstyrene and α-ethylstyrene, substituted styrenes with an alkyl substituent on the ring, such as vinyltoluene and p-methylstyrene, halogenated styrenes, such as monochlorostyrenes, dichlorostyrenes, tribromostyrenes and tetrabromostyrenes;

heterocyclic vinyl compounds, such as 2-vinylpyridine, 3-vinylpyridine, 2-methyl-5-vinylpyridine, 3-ethyl -4-vinylpyridine, 2,3-dimethyl-5-vinylpyridine, vinylpyrimidine, 9-vinylcarbazole, 3-vinylcarbazole, 4-vinylcarbazole, 2-methyl-1-vinylimidazole-vinyloxolane, vinylfuran, vinylthiophene, vinylthiolane, vinylthiazoles, vinyloxazoles; vinyl ethers and isoprenyl ethers;

maleic acid derivatives, such as maleic anhydride, methyl maleic anhydride, maleimide, methylmaleimide, and

dienes, such as divinylbenzene, and also the respective hydroxy-functionalized and/or amino-functionalized and/or mercapto-functionalized compounds.

In general these comonomers are used in an amount of from 0 to 60% by weight, preferably from 0 to 40% by weight and more preferably from 0 to 20% by weight, based on the weight of the monomers, it being possible to use the compounds individually or as a mixture.

These copolymers may also have a hydroxyl and/or amino and/or mercapto functionality in the substituent. Examples of such monomers are vinylpiperidine, 1-vinylimidazole imidazole, N-vinylpyrrolidone, 2-vinylpyrrolidone, N-vinylpyrrolidine, 3-vinylpyrrolidine, N-vinylcaprolactam, N-vinylbutyrolactam, hydrogenated vinylthiazoles and hydrogenated vinyloxazoles.

These monomers are preferably used such that the polymer obtained therefrom has a glass transition temperature in the range from −48° C. to 105° C., in one preferred embodiment from 15 to 85° C.

The polymer containing hydroxyl groups and/or amino groups and/or mercapto groups preferably has a number-average molecular weight of greater than or equal to 5000 g/mol and less than or equal to 100 000 g/mol, more preferably greater than or equal to 7000 g/mol and less than or equal to 80 000 g/mol and very preferably greater than or equal to 10 000 g/mol and less than or equal to 60 000 g/mol.

In one preferred embodiment the polymer containing hydroxyl groups and/or amino groups and/or mercapto groups has a hydroxyl number of greater than or equal to 4 and less than or equal to 80, more preferably greater than or equal to 6 and less than or equal to 60 and very preferably greater than or equal to 8 and less than or equal to 40, without any intention that this should constitute a restriction.

The hydroxyl number indicates how many milligrams of potassium hydroxide are equivalent to the amount of acetic acid which is bound in acetylation by 1000 mg of substance. Since acetylation involves the introduction of an acetyl group into organic compounds containing OH, SH and NH₂ groups, the hydroxyl number also covers SH groups and NH₂ groups.

The polymer containing hydroxyl groups and/or amino groups and/or mercapto groups can have a hydroxyl number of preferably less than or equal to 40 for a number-average molecular weight of greater than or equal to 5000 g/mol and less than or equal to 25 000 g/mol; a hydroxyl number of preferably less than or equal to 20 for a number-average molecular weight of greater than 25 000 g/mol and less than or equal to 60 000 g/mol; and a hydroxyl number of preferably less than or equal to 10 for a number-average molecular weight of greater than 60 000 g/mol and less than or equal to 100 000 g/mol, without any intention that this should constitute a restriction.

The required polydispersity D of the polymer containing hydroxyl groups and/or amino groups and/or mercapto groups, of less than 1.8, preferably less than 1.6, more preferably less than 1.3, can be obtained in a variety of ways. Thus, for example, following a polymerization reaction, the resultant polymer containing hydroxyl groups and/or amino groups and/or mercapto groups, where it has a polydispersity D of greater than 1.6, for example, can be fractionated so as to give individual fractions having a polydispersity D of less than 1.6. This fractionation by molecular weight takes place with the assistance of physical separation methods and is described for example in GB 1,000,185 and DE 3242130. The theoretical principles relating to this separation technique are described for example Hans Georg Elias, Makromoleküle, volume 2, 6th Edition, Weinheim 2001, pages 311-319.

Preference is given to methods where the desired molecular weight and the desired polydispersity can be obtained directly. Particular preference is given to a reactive hot melt adhesive, characterized in that the polymer containing hydroxyl groups and/or amino groups and/or mercapto groups is prepared by a polymerization mechanism which enables a polydispersity D of less than 1.8. Particularly preferred polymerization methods here are ionic polymerization, RAFT polymerization or ATRP. Catalytic polymerization methods using organometallic complexes can also be employed in accordance with the invention.

The mechanism of ionic polymerization is common knowledge in the literature (see Hans Georg Elias, Makromolekule, Volume 1, 6th Edition, Weinheim 1999, pages 214-261) and will not be discussed any further here. The mechanism of ionic polymerization makes it possible to control the molecular weight and the molecular weight distribution during a polymerization.

The particular advantage of what is called ATRP (Atom Transfer Radical Polymerization) over conventional radical polymerization methods is that the molecular weight and the molecular weight distribution can be regulated.

In these methods a transition metal compound is reacted with a compound which has a transferable group of atoms. The transferable group of atoms is transferred to the transition metal compound, thereby oxidizing the metal. In the course of this reaction a radical is formed which undergoes addition to ethylenic groups. The transfer of the group of atoms to the transition metal compound is, however, reversible. Transfer of the group of atoms back onto the growing polymer chain results in the formation of a controlled polymerization system, control being possible over the construction of the polymer, the molecular weight and the molecular weight distribution. Theoretical principles relating to this polymerization mechanism are set out in Hans Georg Elias, Makromolekütle, Volume 1, 6th Edition, Weinheim 1999, page 344. Application examples are disclosed in WO 98/40415, WO 00/47634 and WO 00/34345, to which express reference is made for disclosure purposes.

ATRP may be employed, for example, as follows: Generally speaking, the initiators for ATRP can be described by the formula Y−(X)ₘ, in which Y represents the core molecule, which comprises the polymer. Radical Y is assumed to form free radicals. The radical X represents a transferable atom or a transferable group of atoms and m represents a whole number in the range from 1 to 10, depending on the functionality of the group Y. If m>1, the different transferable X groups of atoms can have a different definition. If the functionality of the initiator is >2, star-shaped polymers are obtained. Preferred transferable atoms and groups of atoms are halogens, such as Cl, Br and/or I, for example.

As mentioned above, the group Y is assumed to form free radicals which act as starter molecules, this free radical undergoing addition to the ethylenically unsaturated monomers. The group Y therefore preferably contains substituents or groups which are able to stabilize free radicals. These substituents include —CN, —COR and —CO₂R, R being in each case an alkyl or aryl radical, and also aryl and/or heteroaryl groups.

Alkyl radicals are saturated or unsaturated, branched or linear hydrocarbon radicals having 1 to 40 carbon atoms, such as methyl, ethyl, propyl, butyl, pentyl, 2-methylbutyl, pentenyl, cyclohexyl, heptyl, 2-methylheptenyl, 3-methylheptyl, octyl, nonyl, 3-ethylnonyl, decyl, undecyl, 4-propenylundecyl, dodecyl, tridecyl, tetradecyl, pentadecyl, hexadecyl, heptadecyl, octadecyl, nonadecyl, eicosyl, cetyleicosyl, docosyl and/or eicosyltetratriacontyl.

Aryl radicals are cyclic aromatic radicals containing 6 to 14 carbon atoms in the aromatic ring. These radicals may be substituted. Examples of substituents are linear and branched alkyl groups having 1 to 6 carbon atoms, such as methyl, ethyl, propyl, butyl, pentyl, 2-methylbutyl or hexyl; cycloalkyl groups, such as cyclopentyl and cyclohexyl; aromatic groups, such as phenyl or naphthyl; ether groups, ester groups and halides. In order to obtain a hydroxyl number in accordance with the invention copolymerization takes place with functionalized monomers. For that purpose a fraction of the monomers carries hydroxyl-functionalized and/or amino-functionalized and/or mercapto-functionalized side groups.

The aromatic radicals include for example phenyl, xylyl, tolyl, naphthyl or biphenyl.

The expression “heteroaryl” characterizes a hetero-aromatic ring system in which at least one CH group has been replaced by N or two adjacent CH groups have been replaced by S or O, such as a radical of thiophene, furan, pyrrole, thiazole, oxazole, pyridine, pyrimidine and benzo[a]furan, which may likewise contain the aforementioned substituents.

The initiator is used generally in a concentration in the range from 10⁻⁴ mol/l to 3 mol/l, preferably in the range from 10⁻³ mol/l to 10⁻¹ mol/l and more preferably in the range from 5*10⁻² mol/l to 5*10⁻¹ mol/l, without any intention that this should constitute a restriction. From the ratio of initiator to monomer the molecular weight of the polymer, if all of the monomer is converted, is given. This ratio is preferably situated in the range from 10⁻³:1 to 0.5:1, more preferably in the range from 5*10⁻³:1 to 5*10⁻²:1.

The polymerization is carried out using catalysts which comprise at least one transition metal. In this context it is possible to use any transition metal compound which is able to form a redox cycle with the initiator or the polymer chain that contains a transferable group of atoms. In the course of such cycles the transferable group of atoms and the catalyst reversibly form a compound, with an increase or decrease in the oxidation state of the transition metal. It is assumed that in the course of this process free radicals are released or captured, so that the concentration of free radicals remains very low. It is, however, also possible that the addition of the transition metal compound to the transferable group of atoms makes it possible or easier for ethylenically unsaturated monomers to undergo insertion into the Y—X bond or Y(M)_{z}—X bond, where Y and X are as defined above and M denotes the monomers, while z represents the degree of polymerization.

Preferred transition metals in this context are Cu, Fe, Cr, Ni, Co, Nd, Sm, Mₙ, Mo, Pd, Pt, Re, Rh, Ir and/or Ru, which are used in appropriate oxidation states. These metals can be used individually and also as a mixture. It is assumed that these metals catalyse the redox cycles of the polymerization, in which case the Cu⁺/Cu²⁺ or Fe²⁺/Fe³⁺ redox couple is active, for example. Accordingly the metal compounds are added to the reaction mixture in the form of halides, such as chloride or bromide, for example, or in the form of an alkoxide, hydroxide, oxide, sulphate, phosphate or hexafluorophosphate, trifluoromethanesulphate. The preferred metallic compounds include Cu₂O, CuBr, CuCl, CuI, CuN₃, CuSCN, CuCN, CuNO₂, CuNO₃, CuBF₄, Cu(CH₃COO), Cu(CF₃COO), FeBr₂, RuBr₂, CrCl₂ and NiBr₂.

It is also possible, however, to use compounds in higher oxidation states, such as CuBr₂, CuCl₂, CuO, CrCl₃, Fe₂O₃ and FeBr₃, for example. In these cases the reaction can be initiated by means of conventional free-radical initiators, such as AIBN, for example. The transition metal compounds are first of all reduced, since they are reacted with the free radicals generated from the conventional free-radical initiators. The reaction in this case is the reverse ATRP as described by Wang and Matyjaszewski in Macromolekules (1995), Vol. 28, pp. 7572-7573.

A further possibility is to use the transition metals as the metal in the zero oxidation state, particularly in a mixture with the aforementioned compounds, for the catalysis, as shown for example in WO 98/40415. In these cases the reaction rate of the conversion can be increased. It is assumed that the concentration of catalytically active transition metal compound is increased by this measure, by virtue of transition metals in a high oxidation state undergoing comproportionation with metallic transition metal.

The molar ratio of transition metal to initiator is generally in the range from 0.0001:1 to 10:1, preferably in the range from 0.001:1 to 5:1 and with particular preference in the range from 0.01:1 to 2:1, without any intention that this should constitute a restriction.

The polymerization takes place in the presence of ligands which are able to form a coordination compound with the metallic catalyst or catalysts. One of the purposes of these ligands is to increase the solubility of the transition metal compound. Another important function of the ligands is to prevent the formation of stable organometallic compounds. This is particularly important, since these stable compounds would not polymerize under the chosen reaction conditions. It is additionally assumed that the ligands facilitate the abstraction of the transferable group of atoms.

These ligands are known per se and are described for example in WO 97/18247, WO 98/40415. These compounds generally contain one or more nitrogen, oxygen, phosphorus and/or sulphur atoms via which the metal atom can be bound. Many of these ligands can be represented generally with the formula R¹⁶-Z-(R¹⁸-Z)ₘ—R¹⁷, in which R¹⁶ and R¹⁷ independently are H, C₁ to C₂₀ alkyl, aryl, heterocyclyl, which if desired may be substituted. These substituents include alkoxy radicals and the alkylamino radicals. R¹⁶ and R¹⁷ may if desired form a saturated, unsaturated or heterocyclic ring. Z is O, S, NH, NR¹⁹ or PR¹⁹, R¹⁹ having the same definition as R¹⁶. R¹⁸ denotes independently a divalent group having 1 to 40 carbon atoms, preferably 2 to 4 carbon atoms, which may be linear, branched or cyclic, such as methylene, ethylene, propylene or butylene group, for example. The definition of alkyl and aryl has been explained above. Heterocyclyl radicals are cyclic radicals having 4 to 12 carbon atoms where one or more of the CH₂ groups in the ring have been replaced by heteroatom groups, such as O, S, NH and/or NR, where the radical R has same definition as R¹⁶.

A further group of suitable ligands can be represented by the formula 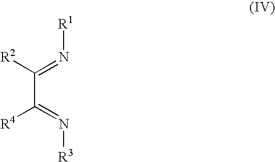
in which R¹, R², R³ and R⁴ independently are H, C₁ to C₂₀ alkyl, aryl, heterocyclyl and/or heteroaryl radical, it being possible for the radicals R¹ and R², and R³ and R⁴, together to form a saturated or unsaturated ring.

Preferred ligands in this context are chelate ligands containing N atoms.

The preferred ligands include triphenylphosphine, 2,2-bipyridine, alkyl-2,2-bipyridine, such as 4,4-di-(5-nonyl)-2,2-bipyridine, 4,4-di(5-heptyl)-2,2-bipyridine, tris(2-aminoethyl)amine (TREN), N,N,N′,N″, N″-pentamethyldiethylenetriamine, 1,1,4,7,10,10-hexa-methyltriethylenetetramine and/or tetramethylethylene-diamine. Further preferred ligands are described for example in WO 97/47661. The ligands can be used individually or as a mixture.

These ligands may form coordination compounds in situ with the metal compounds or they may first be prepared as coordination compounds and subsequently be introduced into the reaction mixture.

The ratio of ligand to transition metal is dependent on the denticity of the ligand and the coordination number of the transition metal. In general the molar ratio is in the range from 100:1 to 0.1:1, preferably from 6:1 to 0.1:1, and more preferably from 3:1 to 0.5:1, without any intention that this should constitute a restriction.

The monomers, transition metal catalysts, ligands and initiators are selected in accordance with the desired polymer solution. It is assumed that a high rate constant in the reaction between the transition metal-ligand complex and the transferable group of atoms is critical for a narrow molecular weight distribution. If the rate constant of this reaction is too low, the concentration of free radicals becomes too high, so that the typical termination reactions occur which are responsible for a broad molecular weight distribution. The rate of exchange is dependent, for example, on the transferable group of atoms, the transition metal, the ligands and the anion of the transition metal compound. Useful hints in selecting these components are found by the person skilled in the art in WO 98/40415, for example.

The polymerization can be carried out under atmospheric, subatmospheric or superatmospheric pressure. The polymerization temperature as well is not critical. In general, however, it is in the range of −20°-200° C., preferably 0°-130° C. and more preferably 60°-120° C.

The polymerization can be carried out with or without solvent. The concept of the solvent is to be given a broad interpretation here.

RAFT polymerization (Reversible Addition Fragmentation Chain Transfer) is likewise based on a free radical mechanism with transfer reactions and, like ATRP, is an important polymerization technique for preparing polymers having a narrow molecular weight distribution and a controlled structure. This mechanism is described in WO 98/01478 and EP 0 910 587, hereby expressly incorporated by reference for purposes of disclosure. Further application examples are disclosed in EP 1 205 492.

The mixing of the compound containing free isocyanate groups with the polymer containing hydroxyl groups and/or amino groups and/or mercapto groups as binder can lead to the formation of a chemical bond between the compound containing free isocyanate groups and the polymer containing hydroxyl groups and/or amino groups and/or mercapto groups. Preferably this bond is obtained by a condensation reaction when the mixture is heated, with the polymer containing hydroxyl groups and/or amino groups and/or mercapto groups functioning as polyol component.

In one preferred embodiment not only the urethane prepolymers but also a product obtainable from the mixing of the compound containing tree isocyanate groups with the polymer containing hydroxyl groups and/or amino groups and/or mercapto groups has a ratio of isocyanate equivalents to hydroxyl and/or amino and/or mercapto equivalents, also known as the isocyanate index, of greater than 1 and preferably not greater than 3. An isocyanate index greater than 3 implies a high level of free isocyanate in the finished adhesive, which when the adhesive is heated to the processing temperature results in the occurrence of toxic vapours. The isocyanate index can be established by a person skilled in the art, for example, during the polycondensation of compounds containing free isocyanate groups and polyhydroxy, polyamino or polymercapto compounds, by reacting these compounds with one another in a specific ratio.

Although the mixture can be used directly as described above for preparing a reactive hot melt adhesive, it is also possible if desired to add additives to the adhesive formulations, such as plasticizers, compatible tackifiers, catalysts, fillers, antioxidants, pigments, stabilizers, and thiol/silane-based adhesion promoters.

The reactive hot melt adhesives obtained in this way are processed preferably at temperatures of approximately 120° C., without any intention that this should restrict the temperature range when processing.

At a temperature of 120° C. these reactive hot melt adhesives preferably have viscosities, measured by the Brookfield method, in the range from 3 to 50 Pa·s, preferably from 3 to 20 Pa·s.

The reactive hot melt adhesives exhibit outstanding properties. These properties include in particular the fact that the adhesives exhibit an outstanding shear strength after final curing. After 7 days of curing at room temperature under standard atmospheric humidity the shear strength is preferably greater than 10 MPa.

These reactive hot melt adhesives likewise have an outstanding viscosity stability at 130° C. After 16 hours at 130° C. they preferably show a viscosity increase of only less than 50%.

These reactive hot melt adhesives also have an outstanding solvent resistance. The extractables fraction of an adhesive was determined after curing.

For this purpose the adhesive was subjected to Soxhlet extraction of methylene chloride over a period of 6 hours. Subsequently the samples thus treated were dried at 75° C. and the weight loss as compared with the initial adhesive was determined by weighing. The extractables fraction determined in this way is preferably below 10 per cent by weight in the case of adhesives of the invention, based on the cured adhesive used at the outset.

Likewise, in one preferred embodiment, these reactive hot melt adhesives can have an opening time, within which the adhesive can be processed, of more than 400 seconds.

1. A mixture for preparing a reactive hot melt adhesive comprising from 10 to 80 per cent by weight of a compound comprising at least one free isocyanate group and comprising from 20 to 90 per cent by weight of a polymer comprising at least one hydroxyl group and/or amino group and/or mercapto group and obtained by polymerizing ethylenically unsaturated monomers, wherein the polymer comprising at least one hydroxyl group and/or amino group and/or mercapto group has a polydispersity D of less than 1.9.

2. The mixture according to claim 1, wherein the polymer comprising at least one hydroxyl group and/or amino group and/or mercapto group is obtained by copolymerizing one or more hydroxy-functionalized and/or amino-functionalized and/or mercapto-functionalized monomers and one or more monomers without hydroxyl and/or amino and/or mercapto functionality of alkyl esters of acrylic or methacrylic acid, vinyl esters, vinyl ethers, fumarates, maleates, styrenes and acylonitriles.

3. The mixture according to claim 1, wherein the polymer comprising at least one hydroxyl group and/or amino group and/or mercapto group has a glass transition temperature in the range from 15 to 85° C.

4. The mixture according to claim 2, wherein the polymer comprising at least one hydroxyl group and/or amino group and/or mercapto group has a number-average molecular weight of greater than or equal to 5000 g/mol and less than or equal to 100 000 g/mol.

5. The mixture according to claim 2, wherein the polymer comprising at least one hydroxyl group and/or amino group and/or mercapto group has a hydroxyl number of greater than or equal to 4 and less than or equal to 80.

6. The mixture according to claim 4, wherein the polymer comprising at least one hydroxyl group and/or amino group and/or mercapto group has a hydroxyl number of less than or equal to 40 for a number-average molecular weight of greater than or equal to 5000 g/mol and less than or equal to 25 000 g/mol.

7. The mixture according to claim 1, wherein the polydispersity of the polymer comprising at least one hydroxyl group and/or amino group and/or mercapto group is adjusted by fractionation according to the molecular weight.

8. The mixture according to claim 1, wherein the polymer comprising at least one hydroxyl group and/or amino group and/or mercapto group is prepared by a polymerization mechanism which enables a polydispersity D of less than 1.8.

9. The mixture according to claim 8, wherein the polymer comprising at least one hydroxyl group and/or amino group and/or mercapto group is obtained by anionic polymerization, RAFT or ATRP.

10. The mixture according to claim 1, wherein the compound comprising at least one free isocyanate group is a low molecular mass diisocyanate and contains an organic radical with an aromatic.

11. The mixture according to claim 1, wherein the compound comprising at least one free isocyanate group is obtained by condensation polymerization of one or more low molecular mass polyisocyanates with one or more polyhydroxy compounds to form a urethane prepolymer.

12. The mixture according to claim 1, wherein the compound comprising at least one free isocyanate group is obtained by condensation polymerization of one or more low molecular mass polyisocyanates with one or more polyamino- and/or polymercapto-containing compounds either alone together with one or more polyhydroxy compounds to form a urethane prepolymer.

13. The mixture according to claim 1, wherein the reactive hot melt adhesive has an isocyanate functionality of greater than 1 and less than or equal to 3.

14. The mixture according to claim 1, wherein the mixture further comprises additives such as plasticizers, compatible tackifiers, catalysts, fillers, antioxidants, pigments, stabilizers and thiol/silane-based adhesion promoters.

15. A reactive hot melt adhesive obtained by condensation reaction of the polymer comprising at least one hydroxyl group and/or amino group and/or mercapto group with the compound comprising at least one free isocyanate group of the mixture according to claim 1.

16. The reactive hot melt adhesive according to claim 15, wherein the reactive hot melt adhesive exhibits a viscosity increase of less than 50% after 16 hours at 130° C.

17. The reactive hot melt adhesive according to claim 15, wherein after curing the reactive hot melt adhesive contains less than 10 per cent by weight of extractables.

18. The reactive hot melt adhesive according to claim 15, wherein the reactive hot melt adhesive has an open time of more than 400 seconds.

19. The reactive hot melt adhesive according to claim 15, wherein the reactive hot melt adhesive has a shear strength after curing of more than 10 MPa.

20. A method for adhesively bonding wood, metal, plastic and glass surfaces or combinations thereof comprising utilizing the reactive hot melt adhesive according to claim 15 to bond the surfaces.
